(19) United States
(12) Patent Application Publication
(10) Pub. No.: US 2018/0365786 A1
(43) Pub. Date: Dec. 20, 2018

(54) System and Method for Verification of a Trust Status

(71) Applicant: SafetyPIN Technologies Inc., Baltimore, MD (US)

(72) Inventor: Jennifer Thompson, Baltimore, MD (US)

(21) Appl. No.: 16/009,736

(22) Filed: Jun. 15, 2018

Related U.S. Application Data
(60) Provisional application No. 62/520,244, filed on Jun. 15, 2017.

(51) Int. Cl. G06Q 50/26; G06F 17/30

(52) U.S. Cl. CPC G06Q 50/265; H04L 9/3236; G06F 17/30876

(57) ABSTRACT

A system and method are provided for verifying the trustworthiness of users in online interactions, with comprehensive risk assessment provided on an ongoing basis by a neutral third party. Users who have obtained favorable assessment can communicate this fact to other online users, across various online platforms, in order to give other users peace of mind in dealing with them and to facilitate online transactions and other interactions.

### CROSS-REFERENCE TO RELATED APPLICATIONS

This application claims priority to, and benefit of U.S. Provisional Application No. 62/520,244, titled “System and Method for Verification of a Trust Status,” filed on Jun. 15, 2017, which is hereby incorporated by reference.

### TECHNICAL FIELD

The present application relates generally to identity verification, background checking and risk management in the context of transacting with other persons using the internet.

### BACKGROUND

Many web sites and mobile applications allow persons to connect with other persons for the purpose of transacting business, obtaining or offering services, or engaging in social relationships. These range from ride sharing services such as Uber and Lyft, to home sharing services such as Airbnb, to services matching care providers with others needing such services such as Care.com and Rover.com, to online dating services such as Match.com and eHarmony.com, to platforms for the sale of goods such as Craigslist.com, as well as many others.

While these web sites and mobile applications have provided increased opportunities and convenience for those who use them, the use of such platforms also comes with risks and uncertainties. When dealing with strangers, sometimes anonymous strangers, one may not know whom to trust. There are risks in interacting with strangers, including financial and safety risks, particularly with in-person interactions. Anonymity can make the online world a dangerous place.

Users would benefit from peace of mind regarding counterparties that they deal with, whether interviewing or hiring some they met on Care.com, meeting up with someone they met on Craigslist.com, dating someone on Match.com or renting a room to or from someone on Airbnb; and so forth. Such peace of mind would protect users from the risk of personal or financial harm, and would allow users to engage in advantageous transactions and interactions that they might otherwise avoid out of concern regarding the trustworthiness of counterparties. Similarly, users would benefit from being able to assure other parties of their own trustworthiness, in order to encourage counterparties to engage in transactions and interactions with them, especially when they can choose others instead.

Some online businesses perform some level of background checks and other vetting of potential users. However, such vetting is applicable only to the particular online business to which it applies. Furthermore, the standards for such vetting are inconsistent across platforms, in terms of type of checking done, frequency of updates, etc. In addition to these limitations, online businesses have an inherent conflict of interest, in that the business has a financial incentive to increase its user and customer base. Thus, users left unsure that the level of risk assessment completed is one that would or should make them feel safer.

There is a need, therefore, for an improved, unbiased, cross-platform system for verifying the trustworthiness of participants in online interactions, and signaling such trustworthiness to other participants, in order to minimize risk and allow more useful interactions to take place online.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a computer-implemented method comprising: receiving, at a processor, personal information of a requestor; generating, by the processor, a plurality of background information requests for background information on the requestor, each background information request based on at least a portion of the requestor's personal information; sending, by the processor, each background information request to a corresponding background information server, each background information server operatively coupled to a respective background information database; receiving, at the processor, a response from each background information server, each response comprising a portion of the background information on the requestor; analyzing, by the processor, each portion of the background information to determine if there is at least one unacceptable background condition for the requestor; and when there is not at least one unacceptable background condition, providing, by the processor, a unique identifier to the requestor, the unique identifier indicating that the requestor's identity is authentic and that the requestor has passed a background check.

In one or more embodiments, sending each background information request to the corresponding background information server comprises sending, by the processor, a credit score request to a credit score server that is operatively coupled to a credit score database. In one or more embodiments, sending each background information request to the corresponding background information server further comprises sending, by the processor, a criminal history check to a criminal history server that is operatively coupled to a criminal history database. In one or more embodiments, sending each background information request to the corresponding background information server comprises sending, by the processor, a litigation history request to a litigation history server that is operatively coupled to a litigation history database. In one or more embodiments, the litigation history request comprises (a) a civil litigation history request, (b) a criminal litigation history request, (c) a bankruptcy litigation history request, or (d) a combination of any one of (a), (b), and (c). In one or more embodiments, sending each background information request to the corresponding background information server comprises sending, by the processor, a police report request to a police report server that is operatively coupled to a police report database.

In one or more embodiments, the unique identifier comprises a graphical unique identifier. In one or more embodiments, the graphical unique identifier is configured to reduce a counterfeiting risk. In one or more embodiments, the graphical unique identifier comprises a link to a website to confirm that the requestor's identity is authentic and that the requestor has passed the background check.

In one or more embodiments, the method further comprises: periodically generating, by the processor, a plurality of updated background information requests for updated background information on the requestor; sending, by the processor, each updated background information request to the corresponding background information server; receiving, at the processor, an updated response from each background information server, each updated response comprising a portion of the updated background information on the requestor; analyzing, by the processor, each portion of the updated background information to determine if there is at least one unacceptable updated background condition for the requestor; and updating, by the processor, an account database with a result of an updated background check.

In one or more embodiments, the method further comprises when there is at least one unacceptable updated background condition for the requestor, revoking, by the processor, the unique identifier from the requestor. In one or more embodiments, the method further comprises analyzing each portion of the updated background information to determine a risk assessment of the requestor; and adjusting a frequency of the periodic generation of the updated background information requests based on the risk assessment. In one or more embodiments, the method further comprises determining, by the processor, a numerical risk assessment of each portion of the background information; and combining, by the processor, each numerical risk assessment to determine an overall numerical risk assessment. In one or more embodiments, the method further comprises normalizing, by the processor, the numerical risk assessment of at least one portion of the background information. In one or more embodiments, the method further comprises normalizing, by the processor, the numerical risk assessment of a criminal history check.

In one or more embodiments, the method further comprises receiving, at the processor, a verification request from a third party, the verification request comprising a request to verify the requestor's unique identifier; querying, by the processor, an account database to determine a status of the requestor's unique identifier; generating, by the processor, a confirmation message when the account database indicates that the requestor's unique identifier is valid; and generating, by the processor, a failure-to-confirm message when account database indicates that the requestor's unique identifier is invalid.

Another aspect of the invention is directed to a system comprising: a processor; a non-transitory memory operatively coupled to the processor, the non-transitory memory comprising computer-readable instructions that cause the processor to: receive, at a processor, personal information of a requestor; generate, by the processor, a plurality of background information requests for background information on the requestor, each background information request based on at least a portion of the requestor's personal information; send, by the processor, each background information request to a corresponding background information server, each background information server operatively coupled to a respective background information database; receive, at the processor, a response from each background information server, each response comprising a portion of the background information on the requestor; analyze, by the processor, each portion of the background information to determine if there is at least one unacceptable background condition for the requestor; and when there is not at least one unacceptable background condition, provide, by the processor, a unique identifier to the requestor, the unique identifier indicating that the requestor's identity is authentic and that the requestor has passed a background check.

Another aspect of the invention is directed to a non-transitory computer-readable medium having computer-executable instructions stored thereon which, when executed by a computer system, cause the computer system to: receive, at a processor, personal information of a requestor; generate, by the processor, a plurality of background information requests for background information on the requestor, each background information request based on at least a portion of the requestor's personal information; send, by the processor, each background information request to a corresponding background information server, each background information server operatively coupled to a respective background information database; receive, at the processor, a response from each background information server, each response comprising a portion of the background information on the requestor; analyze, by the processor, each portion of the background information to determine if there is at least one unacceptable background condition for the requestor; and when there is not at least one unacceptable background condition, provide, by the processor, a unique identifier to the requestor, the unique identifier indicating that the requestor's identity is authentic and that the requestor has passed a background check.

### IN THE DRAWINGS

For a fuller understanding of the nature and advantages of the invention, reference is made to the following detailed description of preferred embodiments and in connection with the accompanying drawings, in which:

FIG. 1 is a block diagram of a system for implementing a SafetyPIN according to one or more embodiments;

FIGS. 2 and 3 illustrate a flowchart for creating and maintaining a SafetyPIN according to one or more embodiments;

FIG. 4 illustrates an example of a SafetyPIN Badge according to one or more embodiments;

FIG. 5 is a block diagram that illustrates the process for generating an alphanumeric identifier associated with each SafetyPIN according to one or more embodiments; and

FIG. 6 is a flow chart for verifying a SafetyPIN according to one or more embodiments.

### DETAILED DESCRIPTION

The present system and method addresses several deficiencies or lack of desired outcomes in the art. The system and method provides online users with an objective, cross-platform means of signaling their trustworthiness to other online users, and verifying the trustworthiness of other online users. The assessment of trustworthiness is based on a thorough risk assessment from a trusted, unbiased third-party source, and is regularly updated.

The system and method disclosed herein is based on a unique identifier, termed a “SafetyPIN,” that can be earned by online users who meet strict vetting criteria. A business entity (“company”) practicing the system and method disclosed herein performs the vetting and issues the SafetyPIN. A customer wishing to obtain a SafetyPIN applies to the company, which performs a thorough, objective risk assessment of the customer, including identity verification, credit history and criminal history, and application of risk assessment algorithms, in order to identify any criminal, financial or potential safety risks.

Once a SafetyPIN is obtained, the customer could then upload, display or deliver a SafetyPIN Badge in connection with various internet interactions, in order to prove that the customer has been vetted by the company, and therefore the customer can be considered trustworthy and dependable, creating a safer interaction. The SafetyPIN Badge could be shared for as long as the customer maintains it in good standing. In order to do so, the customer would be continually and periodically re-assessed by the company to make sure that he or she continues to meet the relevant criteria of trustworthiness. The customer would pay an initial fee to obtain a SafetyPIN, and would pay periodic fees to maintain it; such fees would cover the costs of performing risk assessments. In yet another embodiment, a customer may have a subscription that incurs an automatic periodic payment to maintain the subscription.

Sharing of a customer's SafetyPIN Badge can be performed virtually through the company's online interface. The company maintains a record of who has a currently-valid SafetyPIN. In this way, only a currently-valid SafetyPIN Badge can be shared, providing online counterparties with assurance that the SafetyPIN and SafetyPIN Badge is based on an up-to-date risk assessment of the customer.

In the sharing economy of today, each party to a transaction would like to have the assurance that the other party to the transaction is a trustworthy party. The present system and method allows for one, two or more parties in such cases to cross-check each other's trust status. For example, a family may check a potential child care provider's trust status or SafetyPIN status while the provider can check that the family's home in which the services take place is inhabited by suitable people that can be trusted.

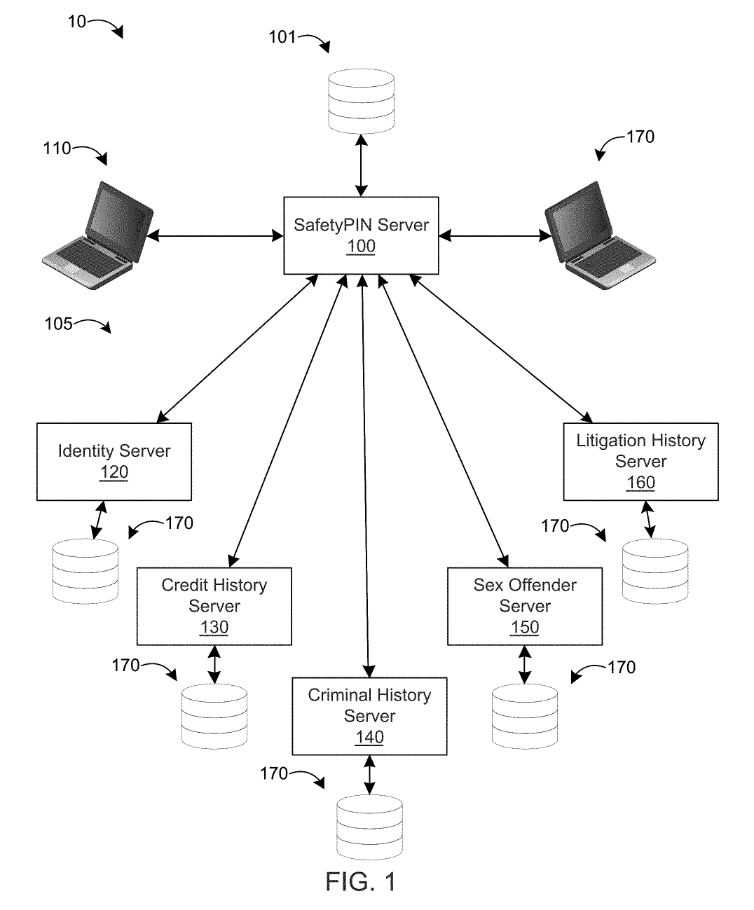

FIG. 1 is a block diagram of a system 10 for implementing a SafetyPIN according to one or more embodiments. The system 10 includes a SafetyPIN server 100 that is in communication with (e.g., operatively coupled to) a SafetyPIN database 101 and to a plurality of servers 105 that are operatively coupled to a respective background information database 170. The server 105 include an identity server 120, a credit history server 130, a criminal history server 140, a sex offender registry server 150, and a litigation history server 160. The SafetyPIN server 100 can include one or more microprocessors, internal memory (e.g., RAM, hard drive(s), etc.), a network port(s) (e.g., wired or wireless), a power supply, and other components. that are configured to execute program instructions, which can be stored on one or more non-transitory media. The non-transitory media can include internal memory (e.g., RAM and/or hard drive(s)) and/or external memory (e.g., a removeable medium such as a disk or a flash drive, or an external hard drive which can be located locally to or remotely from SafetyPIN server 100).

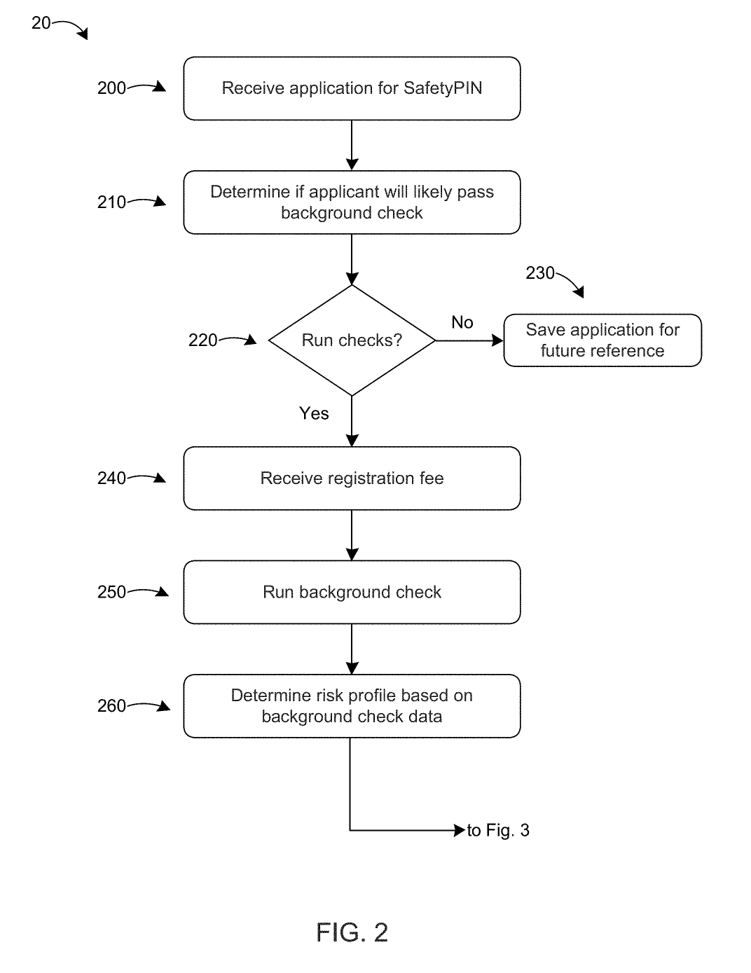

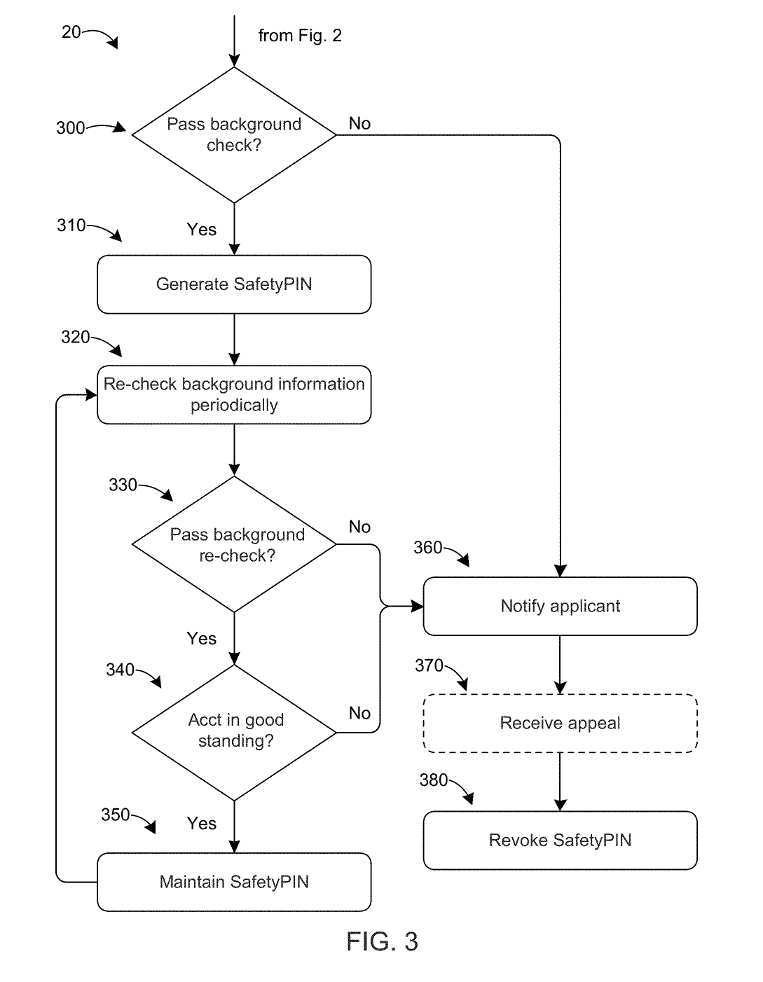

Additional aspects of system 10 are described in connection with FIGS. 2 and 3, which illustrate a flowchart 20 for creating and maintaining a SafetyPIN according to one or more embodiments. To apply for a SafetyPIN, an applicant, using a computer 110, such as a laptop computer, a desktop computer, a tablet, a smartphone, or other device, visits the company's website and fills out an application (e.g., an online application), which is received directly or indirectly by SafetyPIN server 100 in step 200. Alternatively, the applicant can access the application via an application (e.g., a native application or an application for a virtual machine) on applicant's computer 110. The application includes the applicant's identity and address, as well as personal information regarding the applicant. The personal information can include the applicant's birthday, social security number, driver's license number, address(es) of past residence(s), employment history, criminal history (e.g., date, location, offense type, etc.), marital status, credit history, sex offense history, litigation history, and/or other personal or biographical information.

In some embodiments, the application also includes a behavioral screening questionnaire, which can be scored during the background check. The behavioral screening questionnaire includes a series of carefully-constructed behavioral questions. For example, the behavioral questions can be developed with the assistance of experts and/or consultants. In addition, or in the alternative, the behavioral questions can be developed based, at least in part, on research and data analysis from prior applications. The behavioral questions can be multiple choice with answers ranging from 1 (strongly disagree) to 5 (strongly agree). The behavioral questions can have degrees of “right” and “wrong” answers and a numerical score is assigned to each wrong answer, in line with the severity of the answer. For example, an applicant can receive a score of “5” for responding that he/she strongly disagrees with a question for which the “right” response is strongly agrees. At the end of the questionnaire, the SafetyPIN server 100 adds up the numerical scores for the behavioral questions to determine a total behavioral score. The SafetyPIN server 100 then compares the total behavioral score with a threshold (or maximum-acceptable) behavioral score. The applicant passes the behavioral screening questionnaire when his/her total behavioral score is lower than or equal to the threshold behavioral score. The applicant fails the behavioral screening questionnaire when his/her total behavioral score is higher than the threshold behavioral score, which can result in the application being “not approved.” The result of the behavioral screening questionnaire can be an independent non-approval criterion for the application, similar to a negative criminal history (e.g., a felony charge/conviction or a pattern of negative behavior over time (e.g., multiple charges or convictions of driving under the influence (DUI)). In some embodiments, a first set of behavioral questions is included in the application. If the applicant does not meet the approval criteria (i.e., his/her total behavioral score is higher than the threshold behavioral score), the SafetyPIN server 100 can send the applicant additional behavioral questions to confirm that he/she should not pass the behavioral screening questionnaire.

In step 210, the SafetyPIN server 100 analyzes the information provided in the received application and determines, based on that information, whether the applicant is likely or less likely to pass a thorough background check. It is noted that an initial determination of “yes” (i.e., that the applicant is likely to pass the background check) does not necessarily mean that it is actually likely that the applicant will pass the background check. It only means there is no indication, based solely on the information provided in the application, that the applicant may fail the background check. Factors that may decrease the likelihood that the applicant will pass a background check can include (a) whether the applicant has any criminal offenses/convictions, (b) whether the applicant has a poor credit history (e.g., a credit score below a threshold number, prior bankruptcies, etc.), (c) whether the applicant has ever been registered as a sex offender, (d) whether the applicant has been accused of any fraud or deceit in a court or administrative proceeding, and/or (e) whether the applicant's total behavioral score is higher than the threshold behavioral score. The SafetyPIN server 100 can apply different weights to one or more of these and other factors. As discussed above, If the applicant does not have a passing score for the first set of behavioral health questions, the SafetyPIN server 100 can send the applicant additional behavioral questions, prior to determining whether the applicant is likely or less likely to pass a thorough background check, to confirm that he/she should not pass the behavioral screening questionnaire.

The SafetyPIN server 100 indicates the results of the initial determination from step 210 to the applicant (e.g., via the company's website) and asks the applicant in step 220 whether he/she would like to proceed with the application, which involves a thorough background check. In some embodiments, the indication can include a disclaimer (e.g., displayed on the company's website) that the applicant is less likely to be approved for a SafetyPIN based on the information provided in the application. The SafetyPIN server 100, via the company's website, can provide the applicant with detailed information about the scope of the background check, the relevant application or registration fees, and the company's privacy policy. In some embodiments, the company's website can inform the applicant that a higher application fee will be required if the initial determination (step 210) is that the applicant is less likely to pass the background check.

If the applicant decides not to proceed (e.g., if the initial determination is that it is less likely that the applicant will pass the background check or if the applicant changes his/her mind), the SafetyPIN server 100 causes the company's website to terminate the application process. In addition, the SafetyPIN server 100 saves the information from the received application for future reference in step 230. This information may be used again if the applicant decides to re-apply for a SafetyPIN at a later date. For example, the information can be associated with a profile for the applicant. The profile can also indicate when the applicant submitted the application and the results of the initial determination (step 210). The fact that an applicant previously submitted an application but did not proceed with a background check can be used as a factor in future applications for determining whether the applicant is likely or less likely to pass a thorough background check and/or as part of the background check in step 250.

If the applicant decides to proceed (e.g., if the initial determination is that it is likely that the applicant will pass the background check or if the applicant decides to proceed even though the initial determination is that it is less likely that the applicant will pass the background check), the applicant pays the registration or application fee, which is received by the company and the SafetyPIN server 100 in step 240. As discussed above, the registration or application fee can vary based on the initial determination in step 210.

After the registration or application fee is received in step 240, the SafetyPIN server 100 runs a thorough background check on the applicant in step 250. The background check includes sending background information requests to one or more third-party servers 105 (e.g., background information servers) using at least some of the information provided in the application (e.g., applicant's name, address, birth date, and/or social security number). The information requests can be to confirm certain information from the application and/or to determine additional background information on the applicant.

In one example, the SafetyPIN server 100 sends an information request to identity server 120 to confirm the applicant's name, address, birth date, and/or social security number. An example of identity server 120 is a server associated with the registry of motor vehicles, a credit report service (e.g., EXPERIAN, EQUIFAX, or TRANSUNION), or other service. In another example, SafetyPIN server 100 sends an information request (e.g., a credit score request) to credit history server 130 and/or a credit score server (e.g., a server associated with one or more of the credit reporting services described herein) to determine the applicant's credit score, history of defaults or activity by collection agents, and/or to corroborate certain information in the application (e.g., as discussed above). The credit history server 130 can query its background information database 170 to obtain the requested information, and then can send the requested information to SafetyPIN server 100 in a response message(s). In yet another example, SafetyPIN server 100 sends an information request (e.g., a criminal history request) to criminal history server 140 (e.g., a server associated with the Interstate Identification Index or III) to determine whether the applicant has been arrested, indicted, or convicted of a criminal offense. The criminal history server 140 can query its background information database 170 to obtain the requested information, and then can send the requested information to SafetyPIN server 100 in a response message(s). In another example, SafetyPIN server 100 sends an information request to sex offender server 150 (e.g., a server associated with the National Sex Offender Public Website or NSOPF) to determine whether the applicant is registered as a sex offender in any U.S. state or territory. The sex offender server 150 can query its background information database 170 to obtain the requested information, and then can send the requested information to SafetyPIN server 100 in a response message(s). In yet another example, SafetyPIN server 100 sends an information request (e.g., a litigation history request) to litigation history server 160 (e.g., a server associated with the Public Access to Court Electronic Records or PACER) to determine whether the applicant has been sued in criminal or civil court for conduct relating to fraud, deceit, or violence, and/or whether the applicant has filed or petitioned for bankruptcy protection. The litigation history server 160 can query its background information database 170 to obtain the requested information, and then can send the requested information to SafetyPIN server 100 in a response message(s). In another example, SafetyPIN server 100 sends an information request (e.g., a police report request) to police report server to determine whether the applicant has been arrested or cited for any criminal activities. The police report server can query its police report database (e.g., background information database 170) to obtain the requested information, and then can send the requested information to SafetyPIN server 100 in a response message(s). The response from each of the foregoing servers (e.g., servers 120, 130, 140, 150, 160, and the police report server) includes a portion of the overall background information on the applicant or requestor. The SafetyPIN server 100 can also send information requests to and/or search social media websites/applications regarding the applicant.

The results from all sources are aggregated and run through a rules engine on the SafetyPIN server 100. The rules engine can include modules for each type of data input (e.g., criminal history, credit history, etc.). The rules engine can have new rules added to account for state-specific changes in criminal record codes and operations. The rules engine can operate on an assumed-fail basis for all offenses and can have exceptions which allow a pass. Each module of the rules engine is combined to make the final decision. If there is new data that the system has not failed or passed on before, the application may be escalated to a company analyst who will review the data for correctness and make a decision based on documented policy for all factors. If the data and decision are new to the system, a rule may be created to add to the set of rules in the engine, and future encounters with this data will be handled automatically without escalation.

Using the information from the background check (and optionally from the application), the SafetyPIN server 100 determines the applicant's risk profile or risk assessment (in general, risk profile) in step 260. The risk profile or risk assessment can be numerical (e.g., a score of 1-10) or qualitative (e.g., low risk, medium risk, or high risk). The risk profile or risk assessment can be determined by analyzing the background information on the applicant and/or by applying an algorithm to the background check data. In some embodiments, the SafetyPIN server 100 can determine a numerical risk profile score or a numerical risk assessment for each portion of the applicant's risk profile (e.g., each portion of the background information provided by a respective server, as described above), which can then be combined to determine an overall numerical risk profile score or a numerical risk assessment for the applicant. The risk profile can be determined by evaluating various risk factors, such as the type of any criminal offenses, the date or recency of any criminal offenses, behavioral screening results, and/or data gathered from social media and other public sources.

In some embodiments, at least a portion of the applicant's risk profile can be normalized to unity. For example, the same criminal action (e.g., theft) may be categorized differently in different states. One state may categorize the theft as a misdemeanor while another state may categorize the same theft as a felony. Normalizing these types of criminal actions can increase the likelihood that applicants from different geographic locations will be treated consistently (e.g., fairly and/or equally).

In step 300, the SafetyPIN server 100 determines whether there is at least one unacceptable condition from the applicant's background check that prevents the applicant from passing the background check. An example of an unacceptable condition includes a recent conviction or arrest and/or a felony conviction or arrest (recent or in the past). Another example of an unacceptable condition includes a recent pattern of charges in sequence over a course of years which indicates a negative behavior (e.g., multiple charges or convictions of DUI). Another example of an unacceptable condition is a score above a threshold value in a behavioral screening questionnaire (i.e., not passing the behavioral screening questionnaire). Another example of an unacceptable condition is a recent declaration of bankruptcy. Another example of an unacceptable condition is a litigation or crime involving morality or integrity (e.g., fraud). In some embodiments, an unacceptable condition can be a combination of data from the applicant's background check.

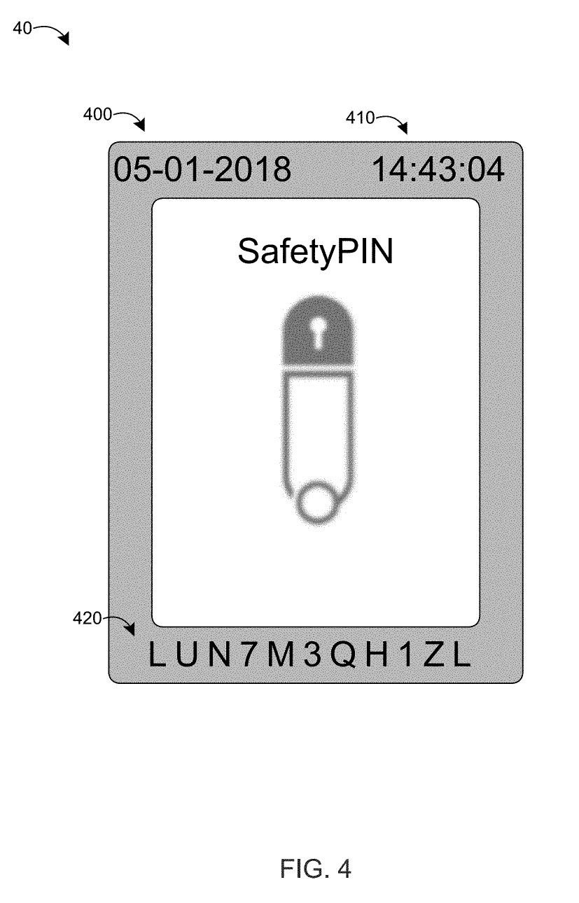

If the applicant passed all background checks and applicant's identity is confirmed, the SafetyPIN server 100 generates a unique SafetyPIN identifier, which can be displayed on a SafetyPIN Badge, and provides the SafetyPIN identifier and/or the SafetyPIN Badge to the applicant in step 310. An example of a SafetyPIN Badge 40 is illustrated in FIG. 4, according to one or more embodiments, which can include a unique graphical identifier to indicate that SafetyPIN is valid. The SafetyPIN server 100 also logs the SafetyPIN Badge 40 and the date and time of its generation in database 101. The applicant can post, upload, or embed the SafetyPIN Badge 40 in user profiles set up on other online platforms, and can send a live SafetyPIN Badge link to others using 2-step verification. The SafetyPIN Badge 40 can include a live link to the company's website, and can comprise features, such as a watermark, to prevent counterfeiting, copying or screenshotting of the SafetyPIN Badge 40.

In step 320, the SafetyPIN server 100 periodically runs additional checks on the applicant's (now the SafetyPIN registrant's (in general, applicant's)) background, which can be the same as or substantially the same as the background check run in step 250. The frequency of such re-checks can be based at least in part on the applicant's risk profile. In addition, the SafetyPIN server 100 can re-check an applicant's background information more frequently if the applicant has a relatively high-risk profile and can re-check an applicant's background information less frequently if the applicant has a relatively high-risk profile. It is noted that the frequency of re-checking can vary over time (e.g., from one background check to the next based on the applicant's updated risk profile). For example, if an applicant's risk profile increases over time, the re-checking frequency can also increase over time. Likewise, if an applicant's risk profile decreases over time, the re-checking frequency can also decrease over time. In some embodiments the re-checking frequency is determined in part by specification from the applicant. After each re-check, the SafetyPIN server 100 optionally determines an updated risk profile for the applicant (e.g., following the same procedures as described in step 260) to determine whether the background re-checking frequency should be updated.

If the SafetyPIN server 100 determines that the applicant passes the background re-check in step 330 (e.g., following the same procedures as described in step 300), the SafetyPIN server 100 then determines in step 340 whether the applicant's account is in good standing. For example, the applicant can be required to pay a periodic fee (e.g., annual, monthly, etc.) to maintain the SafetyPIN. If the applicant's account is in good standing, the SafetyPIN server 100 maintains the applicant's SafetyPIN in step 350 until the applicant's background information is re-checked again in step 320. This loop continues until either the applicant cancels his/her account, the applicant fails to pass a background re-check, or the applicant's account is not in good standing.

If the applicant did not pass the background check in step 300 or the background re-check in step 330, or if the applicant's account is not in good standing in step 340, the SafetyPIN server 100 generates a message to notify the applicant (e.g., a text message, an email message, or other message) in step 360. If the applicant does not agree with the reason(s) for the notification, the applicant can file an appeal, which is received by the SafetyPIN server 100 in step 370. For example, the applicant may not agree with the reasons why he/she failed the background check (or re-check) or with the indication that his/her account is not in good standing. Alternatively, the applicant can cure the reason for the notification, for example by paying any deficient fees. If the appeal is successful, the applicant can apply for reinstatement of his/her SafetyPIN, and then matters proceed as with an initial application, except that the registration fee may be waived in the case of an application for reinstatement

If the applicant does not appeal the reason for the notification, if the applicant's appeal is unsuccessful, or if the applicant does not timely cure the missed payment issue, the SafetyPIN server 100 revokes the applicant's SafetyPIN in step 380. Revoking the SafetyPIN can include notifying the applicant of the revocation and updating the status of the applicant's SafetyPIN in database 101. The SafetyPIN server 100 can also update any “live” SafetyPIN Badges that are associated with applicant's account to indicate that they and the corresponding SafetyPINs are no longer valid. For example, the color, shape, size, and/or other properties of the “live” SafetyPIN Badges can be updated to indicate that they are no longer valid. In one example, the “live” SafetyPIN Badges can be updated so they appear transparent to indicate that they are no longer valid. In another example, a slash or “X” can appear across the “live” SafetyPIN Badges to indicate that they are no longer valid. In another example, the “live” SafetyPIN Badges can appear substantially smaller (e.g., 10-25% the size of a valid SafetyPIN Badge) to indicate that they are no longer valid.

FIG. 4 illustrates an example graphical representation of a SafetyPIN Badge 40. In this example, the SafetyPIN 40 is a graphical image or icon that includes the date 400 and time 410 of applicant's request to create the SafetyPIN Badge 40. For example, SafetyPIN Badge 40 was created on May 1, 2018 at 2:43 pm and 4 seconds. The date 400 and time 410 can be the date and time that the SafetyPIN Badge 40 is initially generated (e.g., in step 310), or it can be a later time, for example if the applicant requests the SafetyPIN server 100 to send a SafetyPIN Badge to a third party (e.g., using 2-step verification) or if the applicant wants to display a recently-requested SafetyPIN Badge to indicate that it is currently valid (i.e., that it is not stale). The SafetyPIN Badge 40 also includes the unique SafetyPIN 420.

The SafetyPIN applicant/registrant can distribute or share his/her SafetyPIN Badge 40 by copying and pasting it, or dragging it from his/her profile on the company to an email, document, social media account, or other location. The SafetyPIN applicant/registrant can also distribute or share his/her SafetyPIN Badge 40 placing an unfurlable link in social media, a chat application, or other location. The unfurlable link can cause the social media application (as an example) to retrieve (e.g., from the SafetyPIN server 100) the SafetyPIN Badge 40 and any other contextual information (e.g., a timestamp) to display an updated “live” SafetyPIN Badge in the social media application. For example, using Open Graph protocols, a link placed in any social media platform (which would normally crawl the page of the site being referenced) will instead pull back the exact SafetyPIN Badge belonging to the SafetyPIN member whose link was posted. This applies to Open Graph enabled chat applications as well.

The SafetyPIN applicant/registrant can also distribute or share his/her SafetyPIN 40 by embedding code (e.g., HTML code) in a website or application that causes the website/application to retrieve the SafetyPIN graphical image or icon (e.g., from the SafetyPIN server 100) to display an updated “live” SafetyPIN in the website/application. The SafetyPIN applicant/registrant can also distribute or share his/her SafetyPIN 40 through email (e.g., by inserting or injecting it in an email).

In some embodiments, the applicant can request an updated SafetyPIN through the company's website, through an application on applicant's computer 110, and/or through a third-party service (e.g., email, social media, ecommerce, etc.) that includes a link to get or display a SafetyPIN. A third party can verify a SafetyPIN and/or a SafetyPIN Badge through the company's website (e.g., by entering the SafetyPIN 420), through an application on the third party's computer, through a third-party service (e.g., email, social media, ecommerce, etc.) that includes a link to verify a SafetyPIN, and/or by clicking on an embedded link in the SafetyPIN Badge 40, which can include a URL to the company's website. To verify the SafetyPIN Badge 40, the SafetyPIN server 100 confirms the SafetyPIN 420 and determines (e.g., by querying database 101) the status of the SafetyPIN 420 and the associated account. If the account is in good standing and the SafetyPIN 420 has an “approved” status, the SafetyPIN server 100 verifies the SafetyPIN 420 and/or the SafetyPIN Badge 40. If the account is not in good standing and/or the SafetyPIN 420 has a status other than “approved” (e.g., denied, pending approval, etc.), the SafetyPIN server 100 does not verify the SafetyPIN 420 or the SafetyPIN Badge 40.

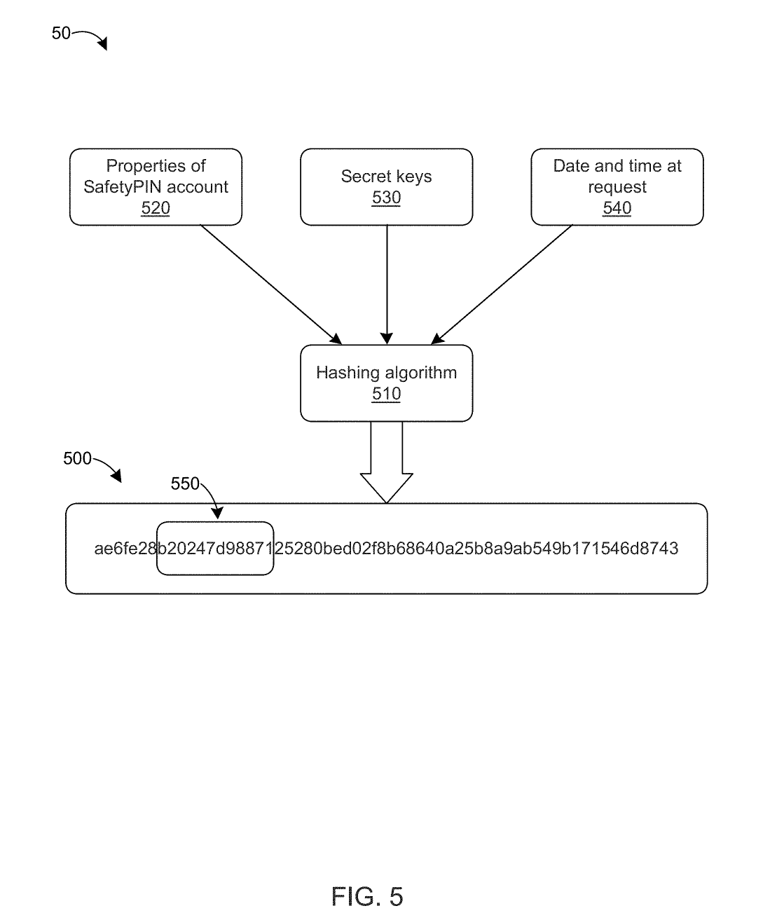

FIG. 5 is a block diagram 50 that illustrates the process for generating an a SafetyPIN 420 associated with each SafetyPIN holder and SafetyPIN Badge 40 according to one or more embodiments. A secure hashing algorithm 510 receives as inputs data or properties 520 of the SafetyPIN holder's (e.g., applicant's) account, one or more secret encryption keys 530, and the date and/or time 540 that the request for the SafetyPIN 550 was received. Examples of data or properties 520 of the SafetyPIN holder's account can include the date and/or time that the account was established, the include the date and/or time that the account was last accessed, his/her name, address, social security number, employment history, and/or any other data associated with the SafetyPIN holder's account. The hashing algorithm outputs alphanumeric identifier 500 that includes a cryptographic signature 550 as a subset of the hashed alphanumeric identifier 500. The cryptographic signature 550 functions as the SafetyPIN 420.

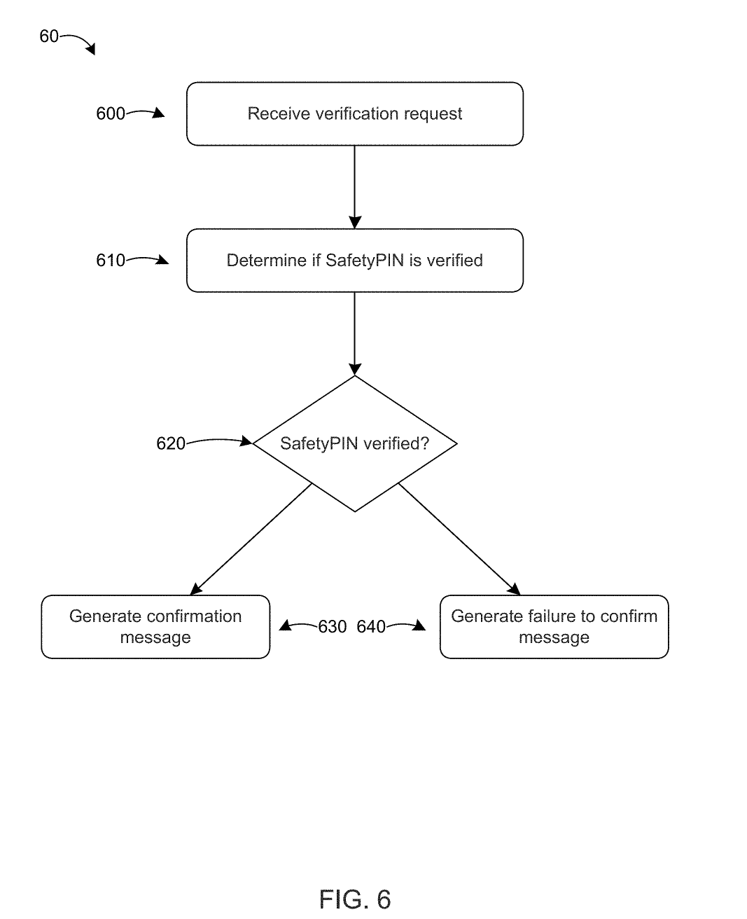

FIG. 6 is a flow chart 60 for verifying a SafetyPIN according to one or more embodiments. In step 600, a verification request is sent by a third party to verify a SafetyPIN, which the third party may have seen on a website, on social media, by text, etc. The third party can initiate the verification request by clicking on the graphical SafetyPIN Badge (e.g., SafetyPIN Badge 40), which includes a link to the company's website for verifying a SafetyPIN. Alternatively, the third party can initiate a verification request by entering certain information regarding the SafetyPIN Badge (e.g., the SafetyPIN and its date of creation) at issue in a verification page on the company's website. The verification request is then received the by the SafetyPIN server 100.

In step 610, the SafetyPIN server 100 determines whether the SafetyPIN can be verified. In some embodiments, the SafetyPIN server 100 determines whether the SafetyPIN can be verified by re-running a background check on the SafetyPIN holder to confirm that the he/she still passes the background check. In addition, or in the alternative, the SafetyPIN server 100 can query an account database (e.g., database 101 or another database) to determine the current status of the individual's account and his/her SafetyPIN. The SafetyPIN server 100 can also query a SafetyPIN database (e.g., database 101 or another database) to determine the status of the SafetyPIN.

In step 620, the SafetyPIN server 100 determines whether the SafetyPIN can be verified. This determination can be based on the information the SafetyPIN server 100 receives in step 610. For example, the SafetyPIN server 100 can analyze the data received from the background re-check to determine if there is at least one unacceptable condition that prevents the applicant from passing the background check (e.g., according to the procedures in step 300) Alternatively, the SafetyPIN server 100 can determine the status of the SafetyPIN by querying the account database and/or the SafetyPIN database. If the status is anything other than “approved” or “verified,” the SafetyPIN server 100 will not verify the SafetyPIN. In addition, the SafetyPIN server 100 can confirm that the individual's account is in good standing (e.g., all fees are paid). In some embodiments, if the individual's account is not in good standing, the SafetyPIN server 100 will not verify his/her SafetyPIN even if the individual has passed the background check (and/or even if the SafetyPIN's status is “approved” or “verified”).

If the SafetyPIN server 100 verifies the SafetyPIN (and optionally that the individual's account is in good standing), the SafetyPIN server 100 generates a confirmation message in step 630. If the SafetyPIN server 100 cannot verify the SafetyPIN (and optionally that the individual's account is in good standing), the SafetyPIN server 100 generates a failure-to-confirm message in step 640. The confirmation or failure-to-confirm message can be displayed on the company's website, it can be sent by email or text message, and/or it can be displayed in the application or website in which the third party requested the SafetyPIN verification (e.g., by clicking on the SafetyPIN Badge).

Those skilled in the art will appreciate many advantages of the invention(s) and disclosure in solving problems of the prior art in the present field. As described and claimed, this disclosure provides a method for validating the identity and determining the risk profile of an individual. This technology is not currently available in the art. Currently, a first online user interacts with a second online user without knowing whether the second online user's identity is the same as that represented by the second online user. For example, the second online user may falsify his/her age, gender, location, occupation, net worth, or other information. In addition, the first online user does not know whether the second online user may pose a security risk prior to conducting business with or meeting the second online user in person.

Thus, the disclosure and claims include new and novel improvements to existing methods and technologies, which were not previously known or implemented to achieve the useful results described above. Users of the present method and system will reap tangible benefits from the functions now made possible on account of the specific modifications described herein causing the effects in the system and its outputs to its users. It is expected that significantly-improved operations can be achieved upon implementation of the claimed invention, using the technical components recited herein, insofar as online users can interact with one another with more confidence, knowing that the other users' identities and risk profiles have been independently verified by the claimed automated systems and methods. Users can also be assured that the same verification standards are applied to all users, thus overcoming a problem in existing systems where an individual website or community applies its own verification standards. The functionality available by the claimed invention, which overcomes problems in the present field, is directly attributable to the present technical modifications and innovations to a data processing system and architecture, including to its processors, programmed instruction sets, data storage and user interface elements. This overall structure and implementation in this technical infrastructure dramatically improve and make more accurate the previously-ad hoc process for user identity confirmation and risk assessment.

In aspects, the method uses machines configured and loaded with data, signals or similar instructions and indicia to implement a set of electronic steps corresponding to uniform identity and risk assessment verification, previously not known nor available to persons practicing in the field, and not possible before configuration of the underlying technical components described herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

It should be understood that the features disclosed herein can be used in any combination or configuration. Thus, for example, in some embodiments, any one or more of the features disclosed herein may be used without any one or more other feature disclosed herein.

The above-described embodiments may be implemented in numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a non-transitory computer-readable storage medium (or multiple non-transitory computer-readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The non-transitory computer-readable medium or media may be transportable, such that the program or programs stored thereon may be loaded onto one or more different computers or other processors to implement various one or more of the aspects described above.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Unless stated otherwise, a computing device or a computer is any type of device that includes at least one processor.

Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software (e.g., low-level language code, high-level language code, microcode), firmware, and/or any combination thereof.

The terms “program” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of the present application need not reside on a single computer or processor, but may be distributed in a modular fashion among a number of different computers or processors to implement various aspects of the present application.

It is to be appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. Variations and modifications of the embodiments described herein, which would occur to persons skilled in the art upon reading the foregoing description, are contemplated by and included in this disclosure.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein. The present materials, methods, and examples are illustrative only and not intended to be limiting.

1. A computer-implemented method comprising:
receiving, at a processor, personal information of a requestor;
generating, by the processor, a plurality of background information requests for background information on the requestor, each background information request based on at least a portion of the requestor's personal information;
sending, by the processor, each background information request to a corresponding background information server, each background information server operatively coupled to a respective background information database;
receiving, at the processor, a response from each background information server, each response comprising a portion of the background information on the requestor;
analyzing, by the processor, each portion of the background information to determine if there is at least one unacceptable background condition for the requestor; and
when there is not at least one unacceptable background condition, providing, by the processor, a unique identifier to the requestor, the unique identifier indicating that the requestor's identity is authentic and that the requestor has passed a background check.

2. The method of claim 1, wherein sending each background information request to the corresponding background information server comprises sending, by the processor, a credit score request to a credit score server that is operatively coupled to a credit score database.

3. The method of claim 2, wherein sending each background information request to the corresponding background information server further comprises sending, by the processor, a criminal history check to a criminal history server that is operatively coupled to a criminal history database.

4. The method of claim 1, wherein sending each background information request to the corresponding background information server comprises sending, by the processor, a litigation history request to a litigation history server that is operatively coupled to a litigation history database.

5. The method of claim 4, wherein the litigation history request comprises (a) a civil litigation history request, (b) a criminal litigation history request, (c) a bankruptcy litigation history request, or (d) a combination of any one of (a), (b), and (c).

6. The method of claim 1, wherein sending each background information request to the corresponding background information server comprises sending, by the processor, a police report request to a police report server that is operatively coupled to a police report database.

7. The method of claim 1, wherein the unique identifier comprises a graphical unique identifier.

8. The method of claim 7, wherein the graphical unique identifier is configured to reduce a counterfeiting risk.

9. The method of claim 7, wherein the graphical unique identifier comprises a link to a website to confirm that the requestor's identity is authentic and that the requestor has passed the background check.

10. The method of claim 1, further comprising:
periodically generating, by the processor, a plurality of updated background information requests for updated background information on the requestor;
sending, by the processor, each updated background information request to the corresponding background information server;
receiving, at the processor, an updated response from each background information server, each updated response comprising a portion of the updated background information on the requestor;
analyzing, by the processor, each portion of the updated background information to determine if there is at least one unacceptable updated background condition for the requestor; and
updating, by the processor, an account database with a result of an updated background check.

11. The method of claim 10, further comprising, when there is at least one unacceptable updated background condition for the requestor, revoking, by the processor, the unique identifier from the requestor.

12. The method of claim 10, further comprising:
analyzing each portion of the updated background information to determine a risk assessment of the requestor; and
adjusting a frequency of the periodic generation of the updated background information requests based on the risk assessment.

13. The method of claim 12, further comprising:
determining, by the processor, a numerical risk assessment of each portion of the background information; and
combining, by the processor, each numerical risk assessment to determine an overall numerical risk assessment.

14. The method of claim 13, further comprising normalizing, by the processor, the numerical risk assessment of at least one portion of the background information.

15. The method of claim 14, further comprising normalizing, by the processor, the numerical risk assessment of a criminal history check.

16. The method of claim 1, further comprising:
receiving, at the processor, a verification request from a third party, the verification request comprising a request to verify the requestor's unique identifier;
querying, by the processor, an account database to determine a status of the requestor's unique identifier;
generating, by the processor, a confirmation message when the account database indicates that the requestor's unique identifier is valid; and
generating, by the processor, a failure-to-confirm message when account database indicates that the requestor's unique identifier is invalid.

17. A system comprising:
a processor;
a non-transitory memory operatively coupled to the processor, the non-transitory memory comprising computer-readable instructions that cause the processor to:
receive, at a processor, personal information of a requestor;
generate, by the processor, a plurality of background information requests for background information on the requestor, each background information request based on at least a portion of the requestor's personal information;
send, by the processor, each background information request to a corresponding background information server, each background information server operatively coupled to a respective background information database;
receive, at the processor, a response from each background information server, each response comprising a portion of the background information on the requestor;
analyze, by the processor, each portion of the background information to determine if there is at least one unacceptable background condition for the requestor; and
when there is not at least one unacceptable background condition, provide, by the processor, a unique identifier to the requestor, the unique identifier indicating that the requestor's identity is authentic and that the requestor has passed a background check.

18. A non-transitory computer-readable medium having computer-executable instructions stored thereon which, when executed by a computer system, cause the computer system to:
receive, at a processor, personal information of a requestor;
generate, by the processor, a plurality of background information requests for background information on the requestor, each background information request based on at least a portion of the requestor's personal information;
send, by the processor, each background information request to a corresponding background information server, each background information server operatively coupled to a respective background information database;
receive, at the processor, a response from each background information server, each response comprising a portion of the background information on the requestor;
analyze, by the processor, each portion of the background information to determine if there is at least one unacceptable background condition for the requestor; and
when there is not at least one unacceptable background condition, provide, by the processor, a unique identifier to the requestor, the unique identifier indicating that the requestor's identity is authentic and that the requestor has passed a background check.
